(19) United States
(12) Patent Application Publication
(10) Pub. No.: US 2016/0324343 A1
(43) Pub. Date: Nov. 10, 2016

(54) MULTI USE PORTABLE MAT

(71) Applicant: LESLIE A. SHERWIN, Gibsonia, PA (US)

(72) Inventor: LESLIE A. SHERWIN, Gibsonia, PA (US)

(21) Appl. No.: 15/147,353

(22) Filed: May 5, 2016

Related U.S. Application Data
(60) Provisional application No. 62/156,943, filed on May 5, 2015.

(51) Int. Cl. A47G 9/10; B32B 5/02; A47G 9/06; A01K 1/015; A47C 1/14

(52) U.S. Cl. CPC A47G 9/1045; A01K 1/0157; A47C 1/143; A47G 9/06; B32B 5/024; B32B 2479/00

(57) ABSTRACT

An article of manufacture includes an outer member with a first and second fabric layers being permanently or releasably secured to each other and defining a hollow chamber. An inner member is disposed within the hollow chamber and has a resiliently compressible layer, a pile layer, a latex layer positioned between an opposite surface of the resiliently compressible layer and an interior surface of another one of the first and second fabric layers, and piping defining a periphery of the inner member and connecting the pile layer and the latex layer. One or more flaps may be attached to one or more edges of the outer member. One or more pockets may be provided on or within the outer member and/or the one or more flaps, and may be accessible from exterior surface(s) of the outer member and/or the one or more flaps.

### CROSS-REFERENCE TO RELATED APPLICATIONS

This application is related to and claims priority from U.S. Provisional Patent Application Ser. No. 62/156,943 filed on May 5, 2015 and entitled “MULTI-USE PORTABLE CHASE MAT”, the entire contents of which are hereby incorporated by reference thereto.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND

1. Technical Field

The subject matter relates to a comfort of an individual or an animal. It further relates to an article of manufacture that can be converted, either fully or partially, between a mat configuration and a pillow configuration.

2. Description of Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It may be uncomfortable for an individual to lay or sit on towels or other types of thin fabric material when sitting in a chair or a chaise lounge, laying-out on a beach or at a pool, sitting on a bench at a sport event, camping and the like activities. Furthermore, construction workers may sleep in their vehicles during certain construction phases. It may be also uncomfortable for pets to lay without padding in cages, pet care, boarding, outdoors or in a vehicle.

### BRIEF DESCRIPTION OF THE DRAWINGS

The accompanying drawings are incorporated in and constitute part of the specification and illustrate various embodiments. In the drawings:

FIG. 1 illustrates an exemplary perspective view of a multi-purpose article of manufacture;

FIG. 2 illustrates an exemplary cross-sectional view of the multi-purpose article of manufacture of FIG. 1;

FIG. 3 illustrates another view of the multi-purpose article of manufacture;

FIG. 4 illustrates a view of the multi-purpose article of manufacture being in a rolled condition;

FIG. 5 illustrates an exemplary perspective view of the multi-purpose article of manufacture;

FIG. 6 illustrates an exemplary perspective view of the multi-purpose article of manufacture;

FIG. 7 illustrates an exemplary 3-D view of the multi-purpose article of manufacture in a combination with a chaise and with one end being partially rolled or folded;

FIG. 8 illustrates an exemplary 3-D view of the multi-purpose article of manufacture in a combination with a chaise;

FIG. 9 illustrates an enlarged view of the folded or rolled end of the article of manufacture of FIG. 7; and

FIG. 10 illustrates an enlarged view of one end of an exemplary multi-purpose article of manufacture.

### DETAILED DESCRIPTION OF EXEMPLARY EMBODIMENTS

Prior to proceeding to the more detailed description of the present invention, it should be noted that, for the sake of clarity and understanding, identical components which have identical functions have been identified with identical reference numerals throughout the several views illustrated in the drawing figures.

The following detailed description is merely exemplary in nature and is not intended to limit the described examples or the application and uses of the described examples. As may be used herein, the words “example”, “exemplary” or “illustrative” means “serving as an example, instance, or illustration.” Any implementation described herein as “example”, “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

References in the specification to “one embodiment”, “an embodiment”, “an exemplary embodiment”, “another embodiment”, “a presently preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in an embodiment”, “in one variation” or similar phrases, as may be used in various places in the specification, are not necessarily meant to refer to the same embodiment or the same variation.

For purposes of description herein, the directional and/or relationary terms such as “upper”, “top”, “lower”, “bottom”, “left”, “right”, “rear”, “back”, “front”, “apex”, “vertical”, “horizontal”, “lateral”, “exterior”, “interior” and derivatives thereof are relative to each other and are dependent on the specific orientation of an applicable element or article, and are used accordingly to aid in the description of the various embodiments and are not necessarily intended to be construed as limiting. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Furthermore, there is no intention to be bound by any expressed or implied theory presented in the preceding technical field, background, or the following detailed description. It is also to be understood that the specific devices and processes illustrated in the attached drawings, and described in the following specification, are simply examples of the inventive concepts defined in the appended claims. Hence, specific dimensions and other physical characteristics relating to the examples disclosed herein are not to be considered as limiting, unless the claims expressly state otherwise.

The term “or” when used in this specification and the appended claims is not meant to be exclusive; rather the term is inclusive, meaning either or both.

The term “couple” or “coupled” when used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The terms “removable”, “removably coupled”, “removably disposed,” “readily removable”, “readily detachable”, “detachably coupled”, “separable”, “separably coupled”, “releasably attached”, “detachably attached” and similar terms, as used in this specification and appended claims, refer to structures that can be uncoupled, detached, uninstalled, or removed from an adjoining structure with relative ease (i.e., non-destructively, and without a complicated or time-consuming process), and that can also be readily reinstalled, reattached, or coupled to the previously adjoining structure.

As may be used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

Anywhere the term “comprising” is used, embodiments and components “consisting essentially of” and “consisting of” are expressly disclosed and described herein.”

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The particular embodiments of the present disclosure generally provide an article of manufacture hereinafter may be also referred to as a chaise cushion and mat or cushioned mat or simply mat, a pet bed, a pet mat, and methods directed to individual and/or animal comfort.

Some embodiments provide a towel-like portable multi-purpose cushioned mat that can be placed where a cushioned surface is required for sitting and/or laying down.

Some embodiments provide at least one of a comfortable, flexible, versatile, portable, machine washable, dryable either in a dryer or when being hang dry portable multi-purpose cushioned mat.

Some embodiments provide a portable multi-purpose cushioned mat that incorporates at least one of a rolled up pillow or a head rest, small, hidden from direct view, pocket with a zipper feature, a larger pocket for personal objects or feet and a third pocket to insert hand and/or body warmers.

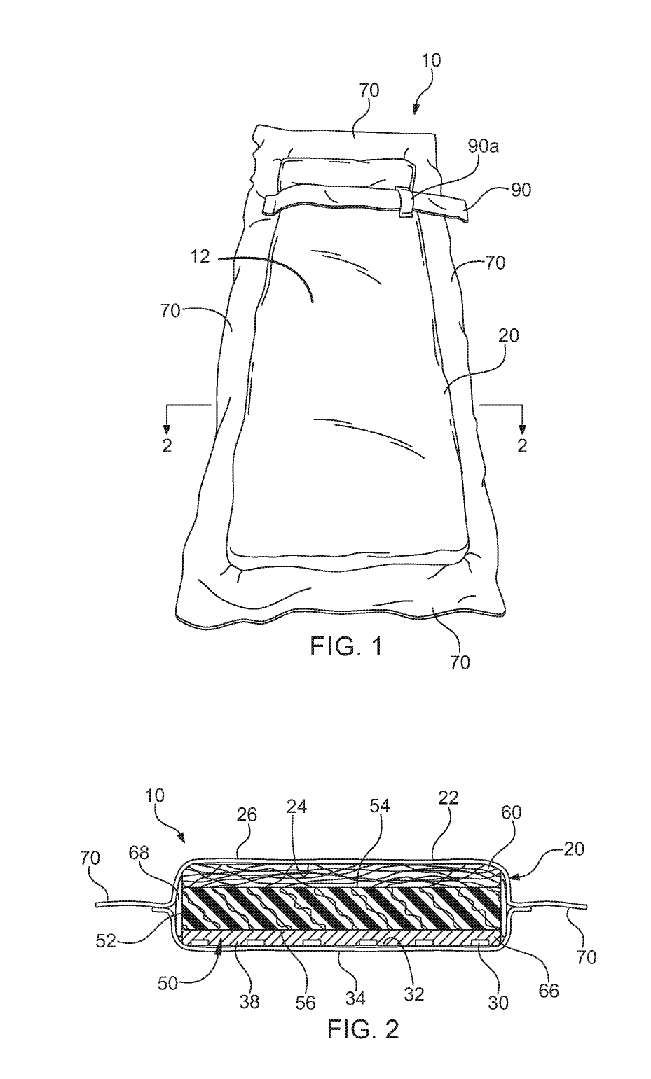

Now in reference to FIGS. 1-10, therein is provided a flexible article of manufacture 10. FIG. 1 illustrates the article of manufacture 10 being in an unrolled or unfolded position. FIG. 2 illustrates a cross-sectional shape of the article of manufacture 10. The article of manufacture 10 comprises an outer member 20. The outer member 20 includes a first fabric layer 22 having an interior surface 24 and an exterior surface 26. The outer member 20 also includes a second fabric layer 30 having an interior surface 32 and an exterior surface 34. The second fabric layer 30 is permanently or releasably (detachably) secured, coupled or connected to the first fabric layer 22 in a manner forming a hollow chamber 38. The access to the hollow chamber 38 may be open or closed during use of the article of manufacture 10. In an embodiment, the first and second fabric layers, 22 and 30 respectively, may define a rectangular or square shaped outer member 20 and being permanently coupled or secured to each other, for example such as by being sewn, at at least two edges to define such open access to the hollow chamber 38. In an embodiment, the first and second fabric layers, 22 and 30 respectively, may define a rectangular or square shaped outer member 20 and being releasably secured to each other at at least two edges, for example with a zipper. In an embodiment, the first and second fabric layers, 22 and 30 respectively, may define a rectangular or square shaped outer member 20 and being secured, coupled or connected to each other at at least two edges with buttons or snaps. In an embodiment, the first and second fabric layers, 22 and 30 respectively, may define a round shaped outer member 20 or outer member 20 of any other shape.

Each of the first and second fabric layers, 22 and 30 respectively, may be manufactured from or comprising a material such as at least one of silk, fleece, satin, cotton, flannel, terry, synthetic material, or any combination thereof. Any other suitable fabric or textile materials are also contemplated herewithin. In an example, the first and second fabric layers, 22 and 30 respectively, do not have to define a wipeable fabric such as a water resistant or water repellent material.

The article of manufacture 10 further comprises an inner member 50. In an embodiment, the inner member 50 comprises a first or resiliently compressible layer, or cushion core, 52 having a first surface 54 and a second surface 56. The resiliently compressible layer 52 may be manufactured from or comprising piping filled with a memory foam material. The resiliently compressible layer 52 may be, without limitations, also any number of suitable materials, including, feathers, cotton, batting, rubberpolyurethane foam, open cell viscoelastic polyurethane foam. There is also a second layer 60 comprising a textile material and being positioned between one surface of the resiliently compressible layer 52 and an interior surface of one of the first and second fabric layers, 22 and 30 respectively, shown as interior surface 24 of the first fabric layer 22. The textile layer 60 may comprise microfibers having a pile essentially comprising raised surface or nap of a fabric, which is made of upright loops or strands of yarn. The textile layer 60 is adhered, for example with glue, to the cushion core 52. The inner member 50 further comprises a third layer 66 manufactured from or comprising a latex material and being positioned between an opposite surface of the resiliently compressible layer 52 and an interior surface of another one of the first and second fabric layers, 22 and 30 respectively, shown as interior surface 32 of the second fabric layer 30. The third layer 66 can be also adhered to the resiliently compressible layer 52. The latex material provides a moisture impermeable layer that can function as a barrier, for example when the article of manufacture is to be laid open on a wet or damp ground surface.

The inner member 50 can further comprise an optional member 68 defining a periphery of the inner member 50 and connecting the layer 60 and the layer 66. The optional member 68 may comprise a fabric material. The optional member 68 may have a substantially round cross-sectional shape in a vertical plane in FIG. 2.

In an embodiment, the layer 66 can be sufficiently flexible to allow the article of manufacture 10 to be rolled and/or folded.

In an embodiment, the inner member 50 may be provided as a one-piece integral construction.

In an embodiment, the inner member 50 may only comprise the resiliently compressible layer 52 and the layer 66.

In an embodiment, the inner member 50 may only comprise the resiliently compressible layer 52 and the layer 60.

In an embodiment, the inner member 50 may only comprise the resiliently compressible layer 52.

In an embodiment, the inner member 50 may be provided as a unitary one piece construction being sewn to outer member 20 around a periphery, or portion(s) of such periphery, of the inner member 50.

In an embodiment, the inner member 50 defines a cushioned moisture absorbent mat.

In an embodiment, the first and second fabric layers, 22 and 30 respectively, are sized differently from each other.

In an embodiment, the first and second fabric layers, 22 and 30 respectively, are sized identical to each other, except for manufacturing tolerances.

The inner member 50 is disposed within the hollow chamber 38 between the first and second fabric layers, 22 and 30 respectively during use of the article of manufacture 10. The inner member 50 may be inserted into the hollow chamber 38 after the first and second fabric layers, 22 and 30 respectively are coupled to each other, as has been described above, or may be placed onto one of the first or the second fabric layers, 22 or 30 respectively so that the opposite one of first and second fabric layers, 22 and 30 respectively can be permanently or releasably secured thereto.

The interior surfaces 24, 32 may abut the respective surfaces of the inner member 50, although portion(s) of air gaps may be permitted. In other words, the first and/or second fabric layers, 22 and 30 may move toward and away from the inner member 50 during use of the article of manufacture 10.

The inner member 50 does not have to be manufactured from open cell foam, chopped foam or foam rubber covered with nylon for waterproofing purposes. The article of manufacture 10, and more particularly the inner member 50, may be configured to absorb excess moisture from the layer 60 while in use. Moisture absorption can be beneficial in providing a cooling affect for the user of the article of manufacture 10, for example when enjoying beach and/or poolside activities.

In an example, the first and second fabric layers, 22 and 30 respectively, are manufactured from or comprising the same material, are not separated from each other and have at least one edge defined essentially by folding of one fabric layer over the other fabric layer.

In an example, the first and second fabric layers, 22 and 30 respectively, may be manufactured from or comprising different materials. The second fabric layer 30 may comprise a water resistant or water repellent material to further aid functionality of the layer 66.

When the first and second fabric layers, 22 and 30 respectively, are sewn to each other, they may be also sewn to the inner member 50, for example to resiliently compressible layer 52 or to the piping member 68, around a portion or portions of the periphery or an entire periphery of the inner member 50.

The article of manufacture 10 may comprise one or more optional flaps 70 attached to one or more edges of the outer member 20 that may be referred to as defining a main portion 12 of the article of manufacture 10. When the one or more flaps 70 are provided, they may be manufactured from or comprising a fabric material being different than material(s) of the first and second fabric layers, 22 and 30 respectively. In one example, fabric material of at least one of one or more flaps 70 is a moisture absorbent material. In one example, one or more flaps 70 can be manufactured from or comprise a fabric material that has a greater flexibility than a flexibility of the inner member 50 and/or greater flexibility than a flexibility of the inner member 50 in a combination with the outer member 20.

The one or more flaps 70 may be defined by one or both of the first and second fabric layers, 22 and 30 respectively. By way of an example only, the first fabric layer 22 may be sized larger than the periphery of the inner member 50. When the second fabric layer 30 is coupled, either detachably or permanently, to the first fabric layer 22, the periphery of the second fabric layer 30 may define inner periphery of the one or more flaps 70. In other words, the one or more flaps 70 can be formed integral with the first fabric layer 22 as a one-piece member. Or, alternatively, the one or more flaps 70 can be formed integral with the second fabric layer 30 as a one-piece member. As was described before, when the second layer 30 is sewn to at least the first layer 22, and when the one or more flaps 70 are made integral with one of the first and second fabric layers, 22 and 30 respectively, the sew lines define the inner periphery of the one or more flaps 70. In a further reference to FIG. 2, the full width of the flap(s) 70 can be defined by one of the first and second fabric layers, 22 and 30 respectively and partially by the other one of the first and second fabric layers, 22 and 30 respectively. The full width of the flap(s) can be defined by both first and second fabric layers, 22 and 30 respectively.

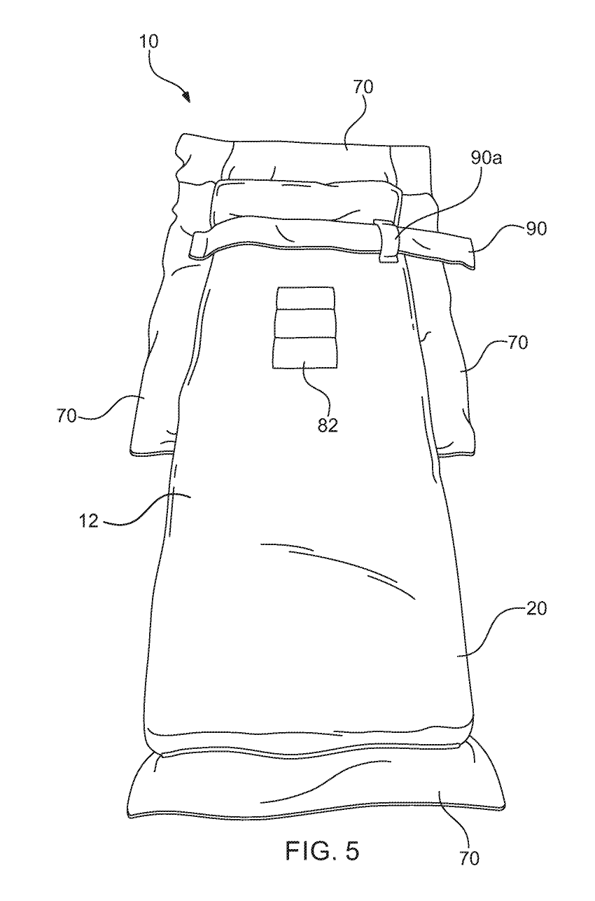

In a particular reference to FIG. 5, it is not necessary for length(s) of the one or more flaps 70 to be sized equivalently to a respective length of the edge of the main portion 12. In an example, a length of at least one flap 70 can be sized smaller than the respective length of the edge of the main portion 12.

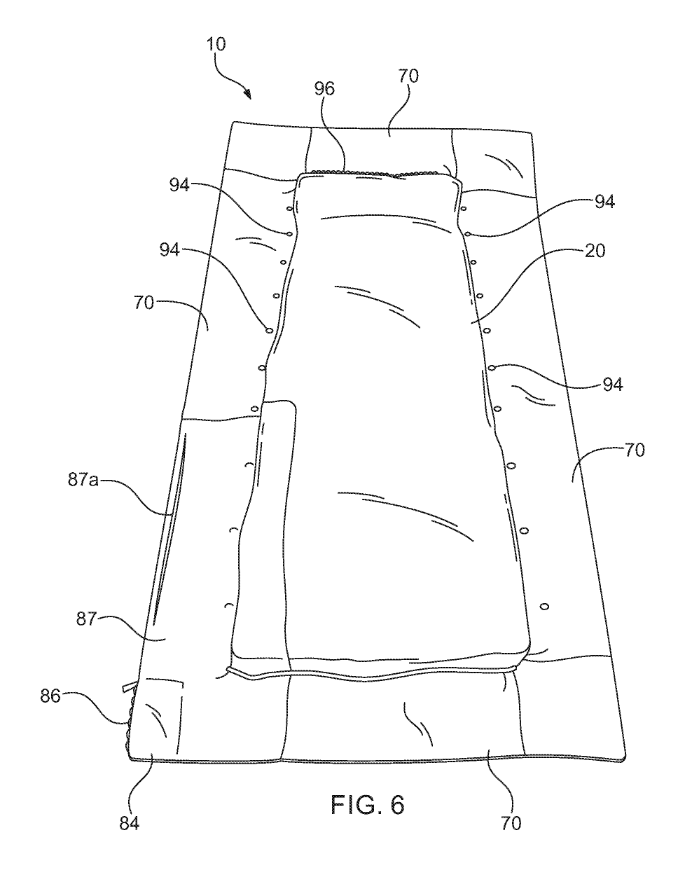

In a particular reference to FIG. 6, the one or more flaps 70 may be detachably coupled to the outer member 20, for example by way of snaps or buttons 94, zipper(s) 96, hook and loop fasteners (not shown) and the like fasteners.

When a plurality of flaps 70 is provided, a width of each flap can be different from a width of another flap 70. In an example of FIGS. 1-6, each of the four flaps 70 can have a different width.

The width of any flap 70 can be about 1″, about 2″, about 3″, about 4″ about 5″, about 6″, about 1″ to about 6″ or greater.

The article of manufacture 10 may also comprise one or more optional pockets provided on or within the outer member 20 and/or the one or more flaps 70, the one or more pockets accessible from exterior surface(s) of the outer member 20 and/or the one or more flaps 70. In reference to FIG. 5, one or more external pockets 82 may be used to house body, feet and/or hand warmers or may be used for keeping personal items, for example such as a cell phone. In reference to FIGS. 6 and 10, at least one pocket 84 may be closed with a fastener 86, for example such as zipper, button(s), hook and loop fastener, fabric ties or the like fasteners. In an embodiment, a pocket 87 may be adapted for storage purposes and comprise an access opening 87a. Such pocket 87 may be adapted with an interior moisture impermeable lining for use as a dry storage compartment. The pocket 87 may be also provided without the interior moisture impermeable lining. The pocket 87 can comprise a transparent material. The pocket 87 can comprise a non-transparent material, wherein a portion of main portion 12 and or flap 70 will be hidden from view.

In an embodiment, the pocket 84 may be hidden from direct view. By way of an example of FIG. 6, the pocket 84 may be provided within the pocket 87. The zipper access 86 may or may not be aligned with the access opening 87a. When pocket 84 is hidden from direct view, the pocket 84 may be employed for storing valuables, for example such as cell phone 4, valet, jewelry and the like.

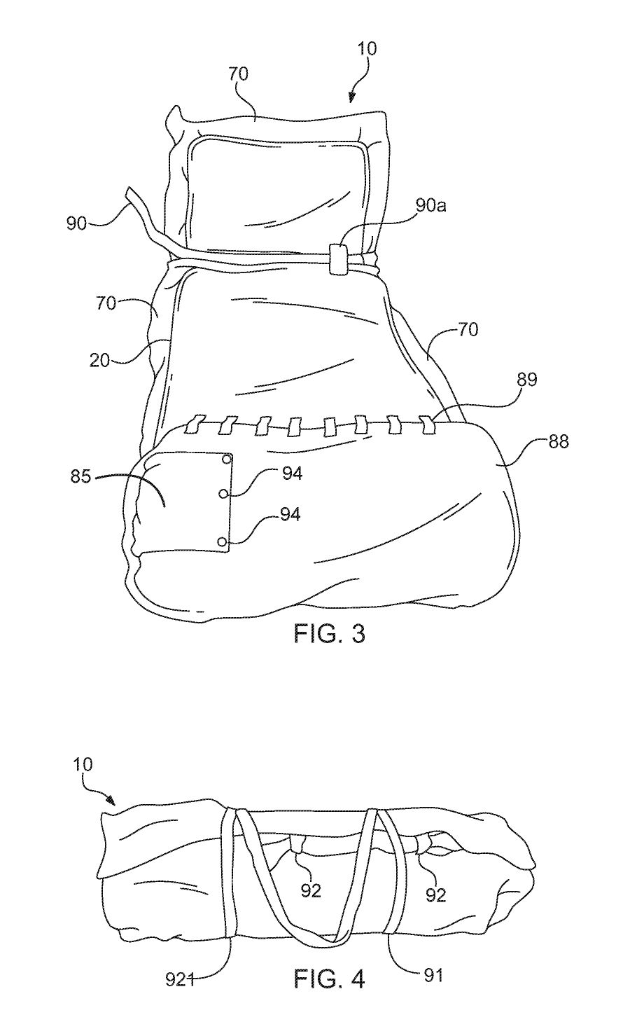

In an embodiment, a pocket 85 may be provided on an exterior surface of another pocket, for example such as pocket 88 of FIG. 3. Pocket 85 and the exterior surface of the article of manufacture 10 may be adapted with pocket closures, for example such as snaps or buttons 94 or any other suitable closure fasteners. Such pocket 88, when provided, may be advantageous in securely storing small or articles (keys, watch, pen, etc) at least during use of the article of manufacture 10.

In an embodiment, and in reference to FIG. 3, a pocket 88 may be provided for storage purposes. In an embodiment, a pocket 88 may be also provided for the user of the article of manufacture 10 to insert his/her feet thereinto. Pockets 88 may be adapted with one or more ties 89. Pocket 87 may be also adapted with one or more ties 89 or any other closure features, for example such as hook and loop fastener, zipper, snaps, buttons and the like fasteners.

Such one or more optional pockets can be manipulated to be in the front or back of the article of manufacture 10. Such one or more optional pockets may be provided in a retention rod and/or a buckle free manner. In an embodiment, when a pocket, for example such as the above described pocket 88, is used for storage purposes and sewn onto the article of manufacture 10 on the opposite side of which a beach going person is laying on, articles, stored within the pocket 88 would remain dry. In an embodiment, the user can put wet or sand soiled article(s) of clothing into the pocket 87, 88 so that such wet or sand soiled article(s) is/are separated from and doesn't/don't contaminate or soil other article(s) of clothing that the user intends to wear.

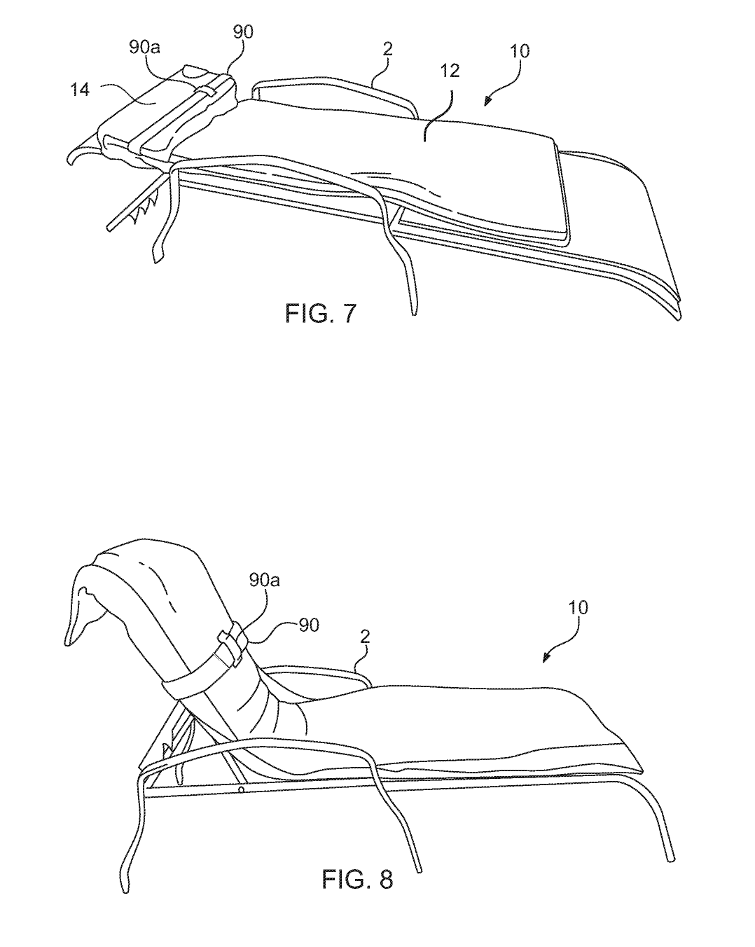

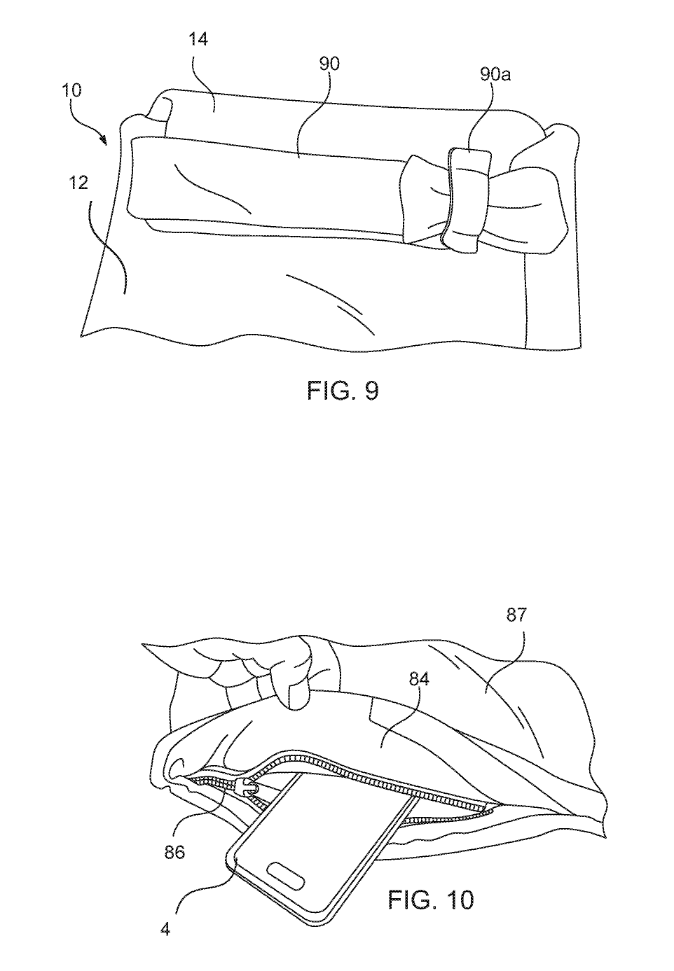

In reference to FIGS. 1, 3, 5, 7 and 9 a long strap 90 can be provided, in a combination with a loop 90a, at one end of the article of manufacture 10 so that it can be partially rolled up and form a pillow configuration, as is best shown in exemplary FIGS. 7 and 9. The long or elongated strap 90 can also be released from the loop configuration and swung around to attach the article of manufacture 10 to various sizes and shapes of chairs and/or chaises 2, as is best shown in exemplary FIG. 8. In other words, the long or elongated strap 90 and the loop 90a are configured, in a combination with each other, to detachably secure the article of manufacture 10 to an article of furniture, for example such as a chaise, 2 or releasably secure one folded end of the article of manufacture 10 to a remaining portion thereof in order to define a pillow portion 14. A length of the long or elongated strap 90 can be selected to encircle the width of the main portion 12 at least once.

In reference to exemplary FIG. 4, the article of manufacture 10 may also comprise one or more optional straps 91 attached, either permanently or releasably, to at least one or two opposite edges of the outer member 20 so as to retain the article of manufacture 10 being in a rolled or folded configuration. The article of manufacture 10 may also comprise one or more carrying straps 91 that may be coupled to outer member 20. The one or more carrying straps 91 may be also provided entirely separately or detachably from the article of manufacture 10. The one or more detachable inter-connected loops may be placed around both ends of the article of manufacture 10 when it is rolled up for portability.

In an embodiment, the article of manufacture 10 comprises one or more pockets.

In an embodiment, the article of manufacture 10 comprises one or more carrying straps 91.

In an embodiment, the article of manufacture 10 comprises an elongated strap 90 and a loop 90a.

The article of manufacture 10 can be used in a mat configuration, wherein the article of manufacture 10 is being laid, partially or completely, open on a surface. In one example, the article of manufacture 10 can be laid open on a grass, sand, concrete and the like natural and manmade surfaces.

When the article of manufacture 10 is used in the mat configuration, the layer 66 of the inner member 50 may be a bottom layer, closest to such surface.

The article of manufacture 10 can be used in a full pillow configuration, wherein the article of manufacture 10 is rolled or folded and is being further secured by way of the one or more straps or ties 92. When the article of manufacture 10 is rolled or folded, it may be secured in this pillow configuration with the above described one or more optional straps 92. Two or three detachable inter-connected loops, that are placed around both ends of the mat when it is rolled up, may be used for portability and carrying/toting. When the article of manufacture 10 is rolled, the diameter of the article of manufacture 10 can be between about 6.5 inches, for example when a length of the article of manufacture 10 is about 24 inches and about 8.5 inches, for example when a length of the article of manufacture 10 is about 67 inches.

The article of manufacture 10 can be used in both the mat and pillow configuration, wherein the article of manufacture 10 is partially rolled or folded. The resulting partial pillow or the head rest 14 may be rolled up or down in a relationship to a top surface of the mat 10. A portion, including an end of the mat opposite to the partial pillow or head rest, may be folded to fit a particular application, for example a recliner chair, or for added comfort. The fully rolled up configuration may be also used as a carrying tote or a “shoulder pack”. As has been discussed above, the one or more detachable inter-connected loops may be placed around both ends of the article of manufacture 10 when it is rolled up for portability. In an example, the mat 10 does not have to use retaining clips with an integral shoulder strap. However, it is contemplated that the pillow or a head rest feature is not permanently built into the mat 10. The user has to partially roll up one end of the mat 10 to form the pillow or the head rest and may optionally strap it down or secure in such configuration, for example with the long strap 90 being attached to the mat 10.

When the article of manufacture 10 is configured or provided in a mat configuration with one or more flaps 70 being manufactured from or comprising a moisture absorbent material, the user of the mat 10 may use such one or more moisture absorbent flaps 70 for drying off or toweling off after enjoying water sports or other water related activities.

In an embodiment, the article of manufacture 10 is being configured for use as a mat or accessory, for water sports or other water related activities.

In an embodiment, the article of manufacture comprises a rectangular outer member comprising a first fabric layer, a second fabric layer permanently or releasably secured to the first fabric layer, and a hollow chamber defined by the first and second fabric layers. A rectangular member is disposed within the hollow chamber between the first and second fabric layers and comprises a resiliently compressible layer, a first layer comprising a resiliently compressible material, a second layer comprising microfibers and being positioned between one surface of the resiliently compressible layer and an interior surface of one of the first and second fabric layers, a third layer comprising a latex material and being positioned between an opposite surface of the resiliently compressible layer and an interior surface of another one of the first and second fabric layers, and piping defining a periphery of the inner member and connecting the second and third layers. The inner member and the outer member being sewn together on all four sides. Four flaps are also provided, each extending from a respective edge of the inner member being sewn to the outer member. In this embodiment, the article of manufactured configured to retain a folded position when being folded at least along its length.

In an embodiment, the article of manufacture comprises an outer member comprising a first fabric layer, a second fabric layer permanently or releasably secured to the first fabric layer, and a hollow chamber defined by the first and second fabric layers. An inner member is disposed within the hollow chamber between the first and second fabric layers and comprising a first layer comprising a resiliently compressible material, a second layer comprising microfibers and being positioned between one surface of the resiliently compressible layer and an interior surface of one of the first and second fabric layers, and a third layer comprising a latex material and being positioned between an opposite surface of the resiliently compressible layer and an interior surface of another one of the first and second fabric layers. One or more flaps extend from one or more edges of the outer member. One or more pockets are provided on or within the outer member and/or the one or more flaps, the one or more pockets accessible from exterior surface(s) of the outer member and/or the one or more flaps. Two or more straps are attached to at least one or two opposite edges of the outer member so as to retain the article of manufacture being in at least a partially rolled or folded configuration.

In an embodiment, a method of providing an accessory for water sports or other water related activities comprises providing an outer member comprising a first fabric layer, and a second fabric layer permanently or releasably secured to the first fabric layer or being formed integral therewith; forming a hollow chamber between the first and second fabric layers; providing an inner member being manufactured from or comprising a combination of resiliently compressible first layer, a second layer comprising microfibers with pile layer positioned between one surface of the resiliently compressible layer and an interior surface of one of the first and second fabric layers, a third layer comprising latex material and being positioned between an opposite surface of the resiliently compressible first layer and an interior surface of another one of the first and second fabric layers, and piping defining a periphery of the inner member and connecting the first layer and the third layer; and positioning the inner member within the hollow chamber between the first and second fabric layers. The method may comprise attaching one or more flaps to one or more edges of the outer member. In an example, the method may comprise manufacturing such one or more flaps from a moisture absorbent material. In an example, the method may comprise manufacturing such one or more flaps from a material having a greater flexibility than the flexibility of the outer member in a combination with an inner member. The method may comprise forming a temporary pillow by folding or rolling a portion of the mat and an optionally securing such temporary pillow with the elongated strap. The method may also comprise attaching one or more pockets to an exterior surface or surfaces of the mat.

In an embodiment, a method of comforting an individual when sitting or laying on a surface, comprises providing an article of manufacture comprising a cushioned or padded main portion, one or more flexible flaps extending from peripheral edge(s) of the main portion and/or one or more pockets on an exterior surface of the article of manufacture; using, in one activity, the article of manufacture in an unrolled or unfolded position; rolling or folding the article of manufacture; carrying or transporting the article of manufacture to a location of another activity; at least partially unrolling or unfolding the article of manufacture at the location of the another activity; and sitting or laying on the at least partially unrolled or unfolded article of manufacture at the location of the another activity. The method may further comprise using the one or more flexible flaps as towels. The method may further comprise using the one or more pockets for carrying or storing articles to be used or used in any one of the one activity or another activity. The method may further comprise providing one pocket as a pocket hidden from direct view and storing articles in this pocket being hidden from direct view.

In an embodiment, the article of manufacture 10 is configured for use as a home or travel pet bed with only one pocket configured to hold treats and a leash. The pocket may or may not be adapted with one or more ties. The pocket can be provided with a zipper, tie(s) or like closure member(s). The article of manufacture 10, configured as a pet bed, can be adapted with straps to secure the bed in rolled condition or be used as a pet leash. The article of manufacture 10, configured as a pet bed can be further configured with flap(s) comprising moisture absorbent material.

Thus, in an embodiment, a method of providing a pet bed comprises providing an outer member comprising a first fabric layer, and a second fabric layer permanently or releasably secured to the first fabric layer; forming a hollow chamber between the first and second fabric layers; providing an inner member comprising a combination of resiliently compressible first layer, a second layer comprising microfibers with pile positioned between one surface of the resiliently compressible layer and an interior surface of one of the first and second fabric layers, a third layer comprising latex material and being positioned between an opposite surface of the resiliently compressible first layer and an interior surface of another one of the first and second fabric layers, and an optional piping defining a periphery of the inner member and connecting the first layer and the third layer; and positioning the inner member within the hollow chamber between the first and second fabric layers. The method can also comprise providing a pocket on an exterior surface of one of the first and second fabric layers. The method can also comprise providing one or more straps.

In an embodiment, a method of providing a pet mat comprises providing an outer member comprising a first fabric layer, and a second fabric layer permanently or releasably secured to the first fabric layer; forming or defining a hollow chamber between the first and second fabric layers; providing an inner member being manufactured from a combination of resiliently compressible first layer, a second layer comprising microfibers with pile positioned between one surface of the resiliently compressible layer and an interior surface of one of the first and second fabric layers, a third layer comprising latex material and being positioned between an opposite surface of the resiliently compressible layer and an interior surface of another one of the first and second fabric layers, and an optional piping defining a periphery of the inner member and connecting the first layer and the third layer; and positioning the inner member within the hollow chamber between the first and second fabric layers. The method may comprise attaching one or more flaps to one or more edges of the outer member and manufacturing such one or more flaps from a moisture absorbent material. The method of using a pet mat may comprise positioning such mat directly near pet ingress/egress location, so that the pet can step directly onto the mat after being outdoors, and using flaps to wipe pet's paws while the pet is standing on the main portion 12 of the mat and even potentially wiping any liquid or dirt spills, thus obviating disadvantages of conventional effort to wipe pet's paws with a separate towel.

When the article of manufacture 10 is configured as a pet bed it can have an advantage over conventional pet beds that are generally bulky, are not easily portable and are not designed for travel. It can also have an advantage over conventional pet beds in providing a firm cushion interior construction by way of pile/foam latex backing. It can also have an advantage over conventional pet beds in that it can easily conform onto a car seat, crate, chair, chaise, etc.

In an embodiment, the article of manufacture 10 is configured for covering a bottom portion of an animal cage for the animal to lay one while in the cage.

In an embodiment, a method of animal comfort while in a cage comprises providing an outer member comprising a first fabric layer, and a second fabric layer permanently or releasably secured to the first fabric layer to form a main portion being sized smaller than a bottom surface of the cage; forming or defining a hollow chamber between the first and second fabric layers; providing an inner member being manufactured from a combination of resiliently compressible first layer, a second layer comprising microfibers with pile layer positioned between one surface of the resiliently compressible layer and an interior surface of one of the first and second fabric layers, a third layer comprising latex material and being positioned between an opposite surface of the resiliently compressible layer and an interior surface of another one of the first and second fabric layers, and an optional piping defining a periphery of the inner member and connecting the first layer and the third layer; positioning the inner member within the hollow chamber between the first and second fabric layers; attaching, either detachably or permanently, one or more flaps to one or more edges of the main portion; positioning the main portion with the one or more flaps onto the bottom surface of the cage; and folding or rolling at least one flap to bridge gap or gaps between the main portion 12 and one or more vertical walls of the cage.

In an embodiment, a method of covering a bottom surface of an animal cage or providing a pet bad or mat, comprises providing an article of manufacture comprising a cushioned or padded main portion and one or more flexible flaps extending from peripheral edge(s) of the main portion; sizing a periphery or an area of the main portion of the article of manufacture to be smaller than an area of the bottom surface of the cage; positioning the article of manufacture on the bottom surface of the cage; and folding or rolling the one or more flaps to cover gap(s) between the peripheral edge(s) of the main portion and wall(s) of the animal cage.

In some, if not all exemplary embodiments, the density of the inner member 50 is selected so that the article of manufacture 10 is provided such that it can be easily manually or machined washed and subsequently dried, particularly being placed in the dryer in one piece and being tumble dry.

In an embodiment, the outer layer 20 of the article of manufacture 10 may be manufactured from a woven fabric or a breathable fabric. In an embodiment, the article of manufacture 10 can be folded longitudinally if needed into a compact form for carrying or storage. In an embodiment, the article of manufacture 10 may have one longitudinally fold line. In an embodiment, the article of manufacture 10 can be folded longitudinally into a compact form. In an embodiment, the article of manufacture 10 can be rolled up into a compact form for carrying. In an embodiment, the article of manufacture 10 can be used as a child's mat. In an embodiment, the article of manufacture 10 can be lightweight. In an embodiment, the article of manufacture 10 can be washable. In an embodiment, the article of manufacture 10 can be easily ported and stored.

In an embodiment, the article of manufacture 10 may be made in two or more sections, each section comprising of polyester pile face, foam with a latex backing, may be used for many activities, including as a child's sleeping mat, may not use handles and instead one or more detachable inter-connected loops that are placed around both ends of the article of manufacture 10 when it is rolled up, may not include securing locking tabs fastened to one face of the article of manufacture 10.

In an embodiment, the article of manufacture 10 can be configured or can be used as a bed or mat for use at the beach, poolside or other outdoor location, may provide a better level of comfort for laying at the beach.

In an embodiment, the article of manufacture 10 can be configured or used in/or on many types chairs or chaise lounges, in both indoor and outdoor environments.

In an embodiment, the article of manufacture 10 does not have an inflatable pillow and a pocket for such pillow.

In an embodiment, the article of manufacture 10 can be configured or can be used for camping, stadium seating or other locations where more comfort in seating is desired.

In an embodiment, the article of manufacture 10 can be configured for sleeping on a surface or on a seat of a vehicle.

In an embodiment, the one or more flaps 70 is/are folded under or on the main portion and/or rolled or folded adjacent edge(s) thereof.

In embodiment(s), the article of manufacture 10 does not have to have an air-tight pad receiving cavity or a cavity that may be inflated and deflated with air, does not have flaps or straps that come together for making a seating arrangement, does not have collapsible features, does not have an inflatable pillow, does not have a mesh and does not need a separate carrying case due, for example, to three or four detachable interconnected loops which are placed around both ends of the mat when rolled up for portability.

In embodiment(s), the article of manufacture 10 may not be intended for use as a placemat or eating mat, a baby bib, only as a beach bag, only as a messenger bag, function as a sheet or a robe or provided with a disposable liner, fixed suction cups, hooks or snaps configuration that secure toys or items to the towel, planar support made of wood, fiberglass or like and/or coupling elements magnetic fasteners, adhesives.

Some of the various exemplary embodiments solve a problem of preventing an individual to comfortably lay and/or sit on a ground surface, bench, lounge chair or chaise 2, while being engaged in activities such as camping, sport events, hunting, festivals, sun tanning and the like activities.

Some of the various exemplary embodiments provide a portable, comfortable and supportively cushioned mat configured to be used by industrial/construction workers who move from job to job and state to state and/or may spend many hours waiting around in their vehicles or even sleep in their vehicles while certain phases of the work are being performed.

Some of the various exemplary embodiments provide a portable, comfortable and supportively cushioned mat configured to be used by resorts and/or hotels for guest comfort at a beach or pool.

Some of the various exemplary embodiments provide a portable, comfortable and supportively cushioned mat that can be used by wheelchair-bound individuals for added comfort. The towel-like flap(s) can be also used, as napkin(s), to aid in maintaining appearance, particularly during eating or feeding efforts. At least one flap 70 can be detachably attached to the main portion for ease of interchangeability without disturbing or moving wheelchair-bound individual. In an example, when the wheelchair-bound individual is finished with the food consumption effort, the individual or his/her caregiver can easily replace soiled flap 70 with a clean one. In an embodiment, a length of one or more flaps 70 is sized smaller than the length of the mat and being further positioned at a top portion of the mat to prevent if not entirely eliminate the one or more flap 70 being caught by the wheel(s) during movement of the wheelchair. Thus, in an embodiment, the article of manufacture 10 is being configured to aid or assist a wheelchair-bound user during food consumption effort.

In an embodiment, a method of comforting and/or grooming an wheel-chair bound individual, comprises providing an article of manufacture comprising a cushioned or padded main portion and one or more flexible flaps extending from peripheral edge(s) of the main portion; positioning the main portion of the article of manufacture on an inner surface of the wheelchair for the individual to sit one during use of the wheelchair; and using the one or more flaps to cover the individual for temperature control and/or aid/assist in maintaining clean appearance of the individual during food consumption effort(s).

In an embodiment, the article of manufacture 10, constructed in accordance with any of the above described embodiments, is configured and/or operable as a multi-use portable mat that the user can easily carry, in a rolled or a folded condition, between uses or activities and convert for a specific use or activity. In an example, the user transports the mat in a rolled position to the beach, unrolls the mat into an unrolled position and opens or extends the flaps outwardly to increase the area of the mat while laying on the sand. The user may roll up a portion of the mat to form a temporary pillow.

The user may use one or more pockets to store personal belongings. The user may use above described pocket 84, being hidden from direct view, to store valuables, for example such as valet, cell phone and the like. When the user desires to relax in the chaise 2 chair instead of laying on the sand, the user simply repositions and mat onto the chaise 2 and may fold the one or more flaps under or over the main portion to fit the mat within chaise 2 confines. When finished with beach activities, the user can re-roll the mat for transport and carry it, by way of carrying straps, to the next activity, for example such as picnicking, where the user unrolls the mat on surfaces, for example such as a grass surface, or use it as a seat cushion at a picnic table. The user may use one or more pockets to carry picnic items, for example such as plates, forks, knives, spoons, napkins and the like. Or the user may use a lined pocket to store any soiled article(s) of clothing.

In an example, the user, going on a camping trip, can roll-up the article of manufacture 10 laying on a chaise 2 and carry it to a vehicle. The user can then unroll the article of manufacture 10, either partially or completely, and position it on a vehicle passenger seat for additional padded or cushioned comfort during the drive. Upon arrival at the camp cite, the user can again roll or fold the article of manufacture 10 and carry it to the camping quarters for use as additional padding while sleeping. Next, for example the following day, the user can carry rolled or folded the article of manufacture 10 to a fishing spot and use it for sitting or laying purposes. Then, upon returning to camp cite, the user can wash and dry the article of manufacture 10 for use at the next activity, for example such as sitting by the bonfire and/or resting during hiking. It will be understood that the article of manufacture 10 can be easily carried in rolled condition by way of straps either in the hand of the user or in a backpack-type fashion. One or more pockets can be used to carry articles that can be used during each activity, for example such as map, flashlight, rain poncho and the like articles that tolerate the article of manufacture 10 being folded or rolled. Thus, essentially, the mat can be also used as a backpack.

In an example, the user going on a vacation can carry the rolled or folded the article of manufacture 10 onto an airplane and place it, either completely unrolled or partially unrolled and defining a pillow, on a seat. If the article of manufacture 10 defines the pillow, the pillow can be easily used as a neck pillow, thus eliminating a need for a separate travel pillow. Furthermore, flaps can be sized to be used as a blanket should an inside temperature be colder than user desires. Next, upon arrival, the user re-rolls or re-folds the article of manufacture 10 and carries it to a hotel, where the article of manufacture 10 is used at the pool or beach, either on a surface or on a chaise 2. The article of manufacture 10 is then dried for use the next day, where the article of manufacture 10 can be used again for added comfort during air travel. The article of manufacture 10 can be washed and dried upon return home.

In an example, the article of manufacture 10 that is configured for use on a chaise 2 can be carried, in a rolled or folded condition, to a city festival to be configured for use on a grass surface of any hard surface.

In an example, an owner of a retail store, that spends long hours at the store, can carry the article of manufacture 10 between the store and home.

In an example, the article of manufacture 10, used in a pet cage, can be removed from the cage and carried, in a rolled or folded condition, to a café that allows pets, where it can be unrolled, for example under the table, so that the pet can lay on. The article of manufacture 10 can be then rolled or folded and carried to the automobile for the pet to lay on. Upon return home, the article of manufacture 10 can be placed on or near the bed for the pet to lay on in order to avoid pet's presence on the bed.

In an example, the article of manufacture 10, used in a pet cage, can be removed from the cage and carried, in a rolled or folded condition, to a pet care to be used by the pet and then carried back home.

In an example, the article of manufacture 10, can be configured for use in a child's booster seat where the child puts his/her feet into the pocket and can use other pocket(s) for toy storage. In an embodiment, the article of manufacture 10 is configured to provide cushioned comfort to an individual.

In an embodiment, the article of manufacture 10 is configured to provide cushioned comfort to an animal.

An unexpected result has been achieved in that the foldability and/or rollability of the article of manufacture 10 comprising inner member 50 with above described layers 52, 60 and 66, outer member 20 and flaps 70, was entirely different than foldability and/or rollability of the inner member 50 by itself.

In an example, two sizes of rectangular inner member 50, 17″ wide by 24″ long and 20″ wide by 32″ long were used. Each size of the inner member 50, rolled or folded two or more times along its width would not retain folded shape, without an additional weight positioned on a top surface thereof when being folded or on an exposed edge when being rolled. The same inner member 50 encased into the outer member 20 and sewn together on all four sides retained folded or rolled shape without any additional weight, even when the outer member 20 comprised such light-weight fabric as fleece.

In an example, two sizes of rectangular inner member 50, 17″ wide by 24″ long and 20″ wide by 32″ long were used. Each size of the inner member 50, folded only once along its length would not retain folded shape, without an additional weight positioned on a top surface thereof when being folded. The same inner member 50 encased into the outer member 20 and sewn together on all four sides and being folded only once along its length retained folded shape without any additional weight on a top surface thereof, even when the outer member 20 comprised such light-weight fabric as fleece.

In an example, two sizes of rectangular inner member 50, 17″ wide by 24″ long and 20″ wide by 32″ long were used. One size of the inner member 50, 17″ wide by 24″ long, folded only once along its width would not retain folded shape, without an additional weight positioned on a top surface thereof when being folded or on an exposed edge when being rolled. The same inner member 50 encased into the outer member 20 and sewn together on all four sides retained folded shape, when being folded only once, without any additional weight, even when the outer member 20 comprised such light-weight fabric as fleece.

In other words, a different result in kind was achieved at least when the inner member 50 by itself was folded along its length as compared to the inner member 50 being encased within the outer member 20 and sewn together on all four sides.

The same results were achieved with the article of manufacture 10 with the outer member 20 comprising different materials being heavier in weight than a weight of the above described fleece material.

The same result was found/achieved with both brand new, unwashed members as well as repeatedly washed members.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer, or section without departing from the teachings herein.

It is to be understood that the features or elements described and illustrated in an embodiment may apply to other embodiment(s). For example, the pockets 84 and 87 in an embodiment of FIGS. 6 and 10 may be incorporated into embodiments of FIGS. 7-8. In an example, the elongated strap 90 and loop 90a of FIG. 1 may be incorporated into an embodiment of FIG. 6.

The recitation of numerical ranges by endpoints includes all numbers subsumed within that range (e.g. 1 to 5 includes 1, 1.5, 2, 2.75, 3, 3.80, 4, and 5).

Any element in a claim that does not explicitly state “means for” performing a specified function, or “step for” performing a specified function, is not to be interpreted as a “means” or “step” clause as specified in 35 U.S.C. §112, 6. In particular, any use of “step of” in the claims is not intended to invoke the provision of 35 U.S.C. §112, ¶6. Furthermore, the Abstract is not intended to be limiting as to the scope of the claimed invention and is for the purpose of quickly determining the nature of the claimed invention.

What is claim is:

1. An article of manufacture comprising:
an outer member comprising:
a first fabric layer,
a second fabric layer permanently or releasably secured to said first fabric layer, and
a hollow chamber defined by said first and second fabric layers;
an inner member encased within said hollow chamber between said first and second fabric layers and comprising:
a first layer comprising a resiliently compressible material,
a second layer comprising microfibers and being positioned between one surface of said resiliently compressible layer and an interior surface of one of said first and second fabric layers, and
a third layer comprising a latex material and being positioned between an opposite surface of said resiliently compressible layer and an interior surface of another one of said first and second fabric layers;
one or more flaps extending from one or more edges of said outer member;
one or more pockets provided on or within said outer member and/or said one or more flaps, said one or more pockets accessible from exterior surface(s) of said outer member and/or said one or more flaps; and
two or more straps attached to at least one or two opposite edges of at said outer member so as to retain said article of manufacture being in at least a partially rolled or folded configuration.

2. The article of manufacture of claim 1, wherein said one or more flaps comprise a fabric material of a greater flexibility than a flexibility of said inner member.

3. The article of manufacture of claim 1, wherein said one or more flaps comprise a moisture absorbent material.

4. The article of manufacture of claim 1, wherein said one or more flaps being configured for a detachable or permanent coupling to said outer member.

5. The article of manufacture of claim 1, further comprising one or more carrying straps.

6. The article of manufacture of claim 1, wherein said latex layer is a moisture impermeable layer.

7. The article of manufacture of claim 1, being configured for use as a mat for water sports or other water related activities.

8. The article of manufacture of claim 1, being configured for use as a pet bed or a pet mat.

9. The article of manufacture of claim 1, being configured for use as a mat in an animal cage, said inner member being sized smaller than an area of the cage and said one or more flaps being folded or rolled to bridge gap(s) between edge(s) of said outer member and wall(s) of the cage.

10. The article of manufacture of claim 1, further comprising a strap on an outer member, said article of manufacture being configured for use on an article of furniture, where said strap and a corresponding portion of said outer member cage a portion of said article of furniture therebetween.

11. The article of manufacture of claim 1, being configured to assist a wheelchair-bound user during food consumption effort.

12. An article of manufacture comprising:
an outer member comprising:
a first fabric layer,
a second fabric layer permanently or releasably secured to said first fabric layer, and
a hollow chamber defined by said first and second fabric layers; and
an inner member encased within said hollow chamber between said first and second fabric layers and comprising:
a first layer comprising a resiliently compressible material,
a second layer comprising microfibers and being positioned between one surface of said resiliently compressible layer and an interior surface of one of said first and second fabric layers, and
a third layer comprising a latex material and being positioned between an opposite surface of said resiliently compressible layer and an interior surface of another one of said first and second fabric layers.

13. The article of manufacture of claim 12, further comprising one or more flaps extending from one or more edges of said outer member, at least one of said one or more flaps comprising a moisture absorbent material.

14. The article of manufacture of claim 12, further comprising one or more flaps extending from one or more edges of said outer member, said one or more flaps comprise a fabric material of a greater flexibility than a flexibility of a combination of said inner and outer members.

15. The article of manufacture of claim 12, said article of manufacture configured for use between a rolled and unrolled positions.

16. The article of manufacture of claim 12, further comprising a first pocket on an exterior surface of one of said inner and outer members, said pocket having an access opening thereinto, and second pocket hidden within said first pocket and having a separate access opening thereinto.

17. The article of manufacture of claim 12, further comprising a strap attached to said outer member and a loop attached to said outer member, said strap and said loop being configured, in a combination with each other, to detachably secure said article of manufacture to an article of furniture or releasably secure one folded end of said article of manufacture to a remaining portion thereof.

18. An article of manufacture comprising:
a rectangular outer member comprising:
a first fabric layer,
a second fabric layer permanently or releasably secured to said first fabric layer, and
a hollow chamber defined by said first and second fabric layers;
a rectangular member encased within said hollow chamber between said first and second fabric layers and comprising:
a resiliently compressible layer,
a first layer comprising a resiliently compressible material,
a second layer comprising microfibers and being positioned between one surface of said resiliently compressible layer and an interior surface of one of said first and second fabric layers, and
a third layer comprising a latex material and being positioned between an opposite surface of said resiliently compressible layer and an interior surface of another one of said first and second fabric layers;
said inner member and said outer member being sewn together on all four sides;
four flaps, each extending from a respective edge of said inner member being sewn to said outer member; and
said article of manufactured configured to retain a folded position when being folded at least along its length.

19. The article of manufacture of claim 18, wherein said four flaps are formed integral with one of said first and second fabric layers as a one-piece member.
